(19) United States
(12) Patent Application Publication
(10) Pub. No.: US 2019/0316932 A1
(43) Pub. Date: Oct. 17, 2019

(54) ANALYSIS, MEASUREMENT AND AUTOMATIC CLASSIFICATION SYSTEM OF ROAD ROUTES AND OPERATION METHOD THEREOF

(71) Applicant: Paolo ANDREUCCI, CASTELNUOVO DI GARFAGNANA (LU) (IT)

(72) Inventor: Paolo ANDREUCCI, CASTELNUOVO DI GARFAGNANA (LU) (IT)

(21) Appl. No.: 16/324,991

(22) PCT Filed: Aug. 11, 2017
(86) PCT No.: PCT/IT2017/000173

§ 371 Date: Feb. 12, 2019

(30) Foreign Application Priority Data
Aug. 12, 2016 (IT) 102016000084942

(51) Int. Cl. G01C 21/36

(52) U.S. Cl. CPC G01C 21/3697; G01C 21/3626

(57) ABSTRACT

The present invention relates to an analysis, measurement and automatic classification system (S) of road routes such as urban and suburban routes, a circuit, a racetrack, from a starting point to an arrival point, for driving a vehicle by a user on said road routes, said system (S) comprising storage means of a base of data to be processed, such as road maps provided with topographical, cartographic, toponomy information, and the like, analysis, measurement and classification rules of these road routes, a control logic unit, operatively connected to said storage means, equipped with processing means of said data to be processed, comprising a calculation program of inferential type that, on the basis of said data, determines and provides as output a drawn map for the driving from said starting point to said arrival point. The present invention also relates to a method for operating said system.

The present invention relates to an analysis, measurement and automatic classification system of road routes.

The present invention also relates to a method of operation of said system.

More specifically, the invention concerns a system of the above type, particularly studied and realized for analysis, measurement and classification, and the following recognition of a progress of a road route, and particularly of bends and straight road sections comprising said urban or extra-urban route, or of any other type of route, to increase safety of drivers of every type of means running along a road, such as motorists, truckers, motorcyclists, cyclists, motor racing drivers, law enforcement and rescue forces and like.

In the following, the description will be addressed to automatic recognition of circuits, tracks or routes, but it is evident that the same should not be considered limited to this specific use.

As it is well known, pilots of car races, motorcycle races or cyclists, rally racings, before the start of the race, usually make a reconnaissance of the racing circuit in order to get “notes” for describing the race route, using a well-defined formalism, aiming to more safely making curves during the race.

The currently adopted method is completely manual.

Particularly, during in the days preceding the race, the pilot and the copilot repeatedly perform reconnaissance racing circuit tours at low speed, with a so-called “touristic” speed.

During these tours, the pilot, based on his experience and knowledge, dictates notes to the copilot, providing to a manual transcription on an on-board notebook, so as to fully describe the entire race route.

Particularly, the notes include three types of data: the curvature radius of the curves, the distance between the curves, the length of the straight road sections, also known as “extensions”, and any significant bumps or gradient variations.

As to the curves, they are classified with a numeric value based on their difficulty level, ranging from 0 to 9, where 0 is a very slow and difficult curve, such as a hairpin curve, and 9 value corresponds to a fast substantially straight section with a very slight curve. In addition to these two data, union signs ca be added determining the speed with which the copilot must dictate the note to the pilot, which, accordingly, must listen to know the information about the road route.

Said union signs of connection are many, the main ones being the following: letter “D” to indicate a right curve; letter “S” to indicate a left curve; “+” sign to indicate a curve that can be taken more easily than a normal curve of equal value; “−” sign to indicate a curve more difficult than a normal curve of equal value; symbol “CON” to indicate that a curve immediately follows another one; letter “E” to indicate that between a curve and the next one there is a distance ranging between 10 and 20 meters; letter “L” to indicate if a curve is long with respect to its radius; letter “K” to indicate that the curve is closed; letter “A” to indicate that the curve opens.

During races taking place at rally events, when the vehicle runs along the racing track, copilot reads the notes to the pilot, so as to anticipate the difficulties arising during the race.

It is obvious that this curve and straight road section annotation procedure is a manual and subjective process, based on the experience and knowledge of the pilot, which is therefore very onerous both in terms of time and in terms of costs involved in carrying it out.

Furthermore, being a manual process, based on the pilot's experience, is susceptible to errors and subjective evaluations not adaptable to other pilots.

For a complete understanding of the method according to the invention, in the following there will be provided definitions of the terms used in the description.

Road maps are the visual representation of a simple, and thus non-oriented and not connected, simple weighed graph, indicated by G=(V,E).

Particularly, V is the set of the vertices of the graph that are geographic coordinates, defined by a latitude value and a longitude value.

Therefore, every point v of the set V is defined as v(lat, lon).

E is the set of the weighed arcs that are the paths connecting one vertex to another one.

Thus, given a starting vertex vₓ and an arrival vertex v_{y}, each arc e of the set E is defined as e(vₓ, v_{y}).

The weight of the single arc e(vₓ, v_{y})is defined as the length in meters of the path connecting the two vertices vₓ and v_{y} that are the extremes of the path.

By bounding box it is meant a rectangle identified by at least one pair of geographic coordinates C1 (lat₁, long₁) and C2 (lat₂, long₂) that on a cartographic map respectively indicate the top left vertex of the rectangle and the bottom right vertex of the rectangle.

The extension of a bounding box can be variable, its maximum extension corresponds to the coverage of the entire Earth planet.

As a bounding box it is also possible using a regular polygon having a predetermined number of vertices determined by points having a precise longitude and a precise latitude.

By sub graph it is meant is a graph G1=(V₁, E₁), wherein V₁⊆in V and E1⊆in E.

By path in a graph it is meant line connecting a vertex v₁ to a vertex v2 of a graph G and it is defined as the ordered set of arcs connecting vertex v₁ to vertex v₂.

By road route in a map it is meant the graphical view of the path, of which the path is the numerical formalization.

By segment it is meant the geodetic line connecting two points along the Earth's surface.

Converting an arc into a segment involves the following operations: known vertices v₁ and v2, the segment is detected by geodetically connecting v₁ and v₂, taking into account the radius of Earth curve.

By track it is meant an ordered set of consecutive segments wherein the angle between a segment and the next one can be acute, dull, and null.

On the same track, the angle between all the segments contained in the same, consecutive in pairs, must always have the same width, thus three types of track are defined: a track where the angles are all acute angles, a track where the angles are all dull angles and a track where the angles are all null angles.

A routing algorithm or minimum path calculation is implemented using the known Dijkstra algorithm.

These notions are contained in the text, here incorporated by reference: Cormen, Thomas H.; Leiserson, Charles E.; Rivest, Ronald L.; Stein, Clifford (2001). “Section 24.3: Dijkstra's algorithm”. Introduction to Algorithms (Second ed.) MIT Press and McGraw-Hill. pp. 595-601. ISBN 0-262-03293-7.

In the light of the above, it is an object of the present invention that of providing a system for the automatic recognition of road routes of any kind, such as urban, extra-urban, circuit or race routes and the like, providing objective and without errors data and therefore that can be proposed to all drivers of vehicles that can run on said routes.

Another object of the present invention is that of recognizing a plurality of road routes connecting a single starting point to the same arrival point so that a driver or pilot can individuate and choose the road route most suited to its needs.

Another object of the present invention is to enable a driver or a pilot to know before the difficulties in a road, in order to allow safe driving.

Another object of the present invention is that of providing a system for automatically recognizing road routes, in which also dictation of notes occurs automatically.

It is therefore specific object of the present invention an analysis, measurement and automatic classification system of road routes such as urban and suburban routes, a circuit, a racetrack, from a starting point to an arrival point, for driving a vehicle by a user on said road routes, said system comprising storage means of a base of data to be processed, such as road maps provided with topographical, cartographic, toponomy information, and the like, analysis, measurement and classification rules of these road routes, a control logic unit, operatively connected to said storage means, equipped with processing means of said data to be processed, comprising a calculation program of inferential type that, on the basis of said data, determines and provides as output a drawn map for the driving from said starting point to said arrival point.

Furthermore, according to the invention, said system can comprises association means of sounding signals to said drawn map, capable to inform said user while he drives along said road route.

Still according to the invention, said system can comprise display and interface means of said drawn map, such as a display and the like.

It is further object of the present invention an analysis, measurement and automatic classification method of road routes such as urban and suburban routes, a circuit, a track, a racetrack and the like, from a starting point to an arrival point, for driving a vehicle by a user on said road routes, implemented by the system (S) according to the preceding claims, comprising the following steps:
a. calculating a route which connects said starting point to said arrival point, comprising a set of segments, each having a starting point A and a final point B;
b. converting said route calculated in said step a. in a broken line comprising segments;
c. normalizing said segments of said broken line;
d. associating to each segment of said broken line a length and the angle that is formed between two subsequent segments and giving as output a group of tracks;
e. correcting errors of said group of tracks;
f. analyzing the tracks obtained from the preceding step e., evaluating the length, the sinuosity, the radius of curvature of the tracks and the distance between two curves, this latter given by the length of the rectilinear tracks which separate two curves and assigning preliminary notes to each of the tracks;
g. checking the coherence of said preliminary notes and generation of final notes. Still according to the invention, said step b. comprises the following sub-steps:
b1. calculating the length of each segment of said broken line as the geodetic between the spatial coordinate of the said starting point A and the spatial coordinate of said final point B on the terrestrial sphere, by means of the following formula:

lunghezza=R*arccos (sin(latA)*sin(latB)+cos(latA)*cos(latB)*cos(lonA−lonB)) (1)
b2. calculating the angle θ that each segment forms with respect to the meridian, as the direction from said starting point A to said final point B of each segment using the following formulas:

$$\begin{matrix}{Δ}_{ϕ} = ln ( tan ( \frac{latB}{2} + \frac{π}{4} ) / tan ( \frac{latA}{2} + \frac{π}{4} ) ) & ( 2 ) \\ Δ lon = \vert lonA - lonB \vert & ( 3 ) \\ θ = atan 2 ( Δ lon , {Δ}_{ϕ} ) & ( 4 )\end{matrix}$$

wherein Δ_{φ} is the difference of latitude between said starting point A and final point B, and Δlon is the difference of longitude between said starting point A and final point B.

Furthermore, according to the invention said step c. comprises the following sub-steps:
c.1 evaluating the length of the segment,
c.2 if said length is greater than a predetermined threshold, such as 18 m, said segment is divided into segments of length less than or equal to 18 m.

Preferably according to the invention, in said step d. it is calculated the angle between a segment and the following one, projecting said starting point A and final point B of each segment on a plane and applying the known formula for the calculation of the angle γ between two straight lines on a plane:

$$γ = arctan ( \vert \frac{m - {m}^{′}}{1 + {mm}^{′}} \vert ) \qquad ( 5 )$$

wherein m and m′ are the angular coefficients of two consecutive segments.

Always according to the invention, said step e. comprises the following sub-steps:
e.1 selecting a current track, if there are not also a previous track and a subsequent track, no error correction is carried out, but if there are a previous track and a subsequent track, a sub-step e.2 occurs;
e.2. checking the presence of the error of type one, if it is present then it is corrected and the following track is analyzed, if there is no error, a sub-step e.3 occurs;
e.3. checking the presence of the error of type two, if it is present then it is corrected and the following track is analyzed, if there is no error, a sub-step e.4 occurs;
e.4. checking the presence of the error of type three, if it is present then it is corrected and the following track is analyzed, if there is no error, a sub-step e.5 occurs;
e.5. checking the presence of the error of type four, if it is present then it is corrected and the following track is analyzed, if there is no error, the following track is at the same analyzed.

Preferably, according to the invention, said step f. comprises the following sub-steps:
f.1 checking the type of the track, if it is a curve track followed by another curve track, running a sub-step f.2 or if it is a curve track followed by a straight track and then by another curve track, running a sub-step f.3, if there are no subsequent tracks, ending the sub-step f.1;
f.2 if the curves have opposite directions, giving out two notes for two opposite curves, if the two curves have the same direction, running a sub-step f.21;
f.21 evaluating the curve on the basis of the values of the relative trace: the radius of curvature, sinuosity, length and angle, if the curves are unifiable according to predetermined criteria, running a sub-step f.22, if the curves are tied together, running a sub-step f.23, if the curves are untied, running a sub-step f.24;
f.22 generating a new note by assigning to the attribute “tracks” the two tracks obtained by tying;
f.23 if the curves are tied to each other, generating two notes, one for each curve track, and tying them to each other by assigning to the attribute “following note” the second note;
f.24 if the curves are untied, generating two distinct notes, one for each curve;
f.3. if the curves have opposite directions, generating two notes for the two opposed curves and one note for the extension, if the two curves have the same direction, running a sub-step f.31 to evaluate such extension by means of predetermined rules, in the case of a long extension, the two curves are completely untied and separated by a substantial extension, generating three distinct notes, one for each curve and one for the extension, in case of a short extension, running a sub-step f.32 to evaluate the two curves;
f.32 evaluating the two curves, if they are unifiable to form a single curve, running a sub-step f.33, if the curves are tied together, running a sub-step f.34;
f.33 generating a new note by merging the track of the first curve, the track of the successive extension and the track of the second curve and then erasing the three merged tracks;
f.34 generating two notes, one for each curved track, and merging them together by assigning to the attribute “following note” the second note, if the curves are untied, running the sub-step f.35;
f.35 generating three distinct notes, one for each track.

Still, according to the invention, said step g. comprises the following sub-steps:
g.1 evaluating the preliminary notes coming from the preceding step f. and distinguish between a note for an extension and a note for a curve;
g.2 if the note is for an extension, evaluating the extension, if it is less than 100 m it is deleted, if it is greater than 100 meters, the preliminary note becomes a final note;
g.3 if the note relates to a curve, running an evaluation step of the note and classifying it a final note.

Preferably, according to the invention, said method can comprise a step of dictating said final notes during the driving of said vehicle in which a calculation is made of the moment in which dictating the note related to the position of the vehicle.

The present invention will now be described in an illustrative but not limitative way according to its preferred embodiments, with particular reference to the figures of the enclosed drawings, wherein:

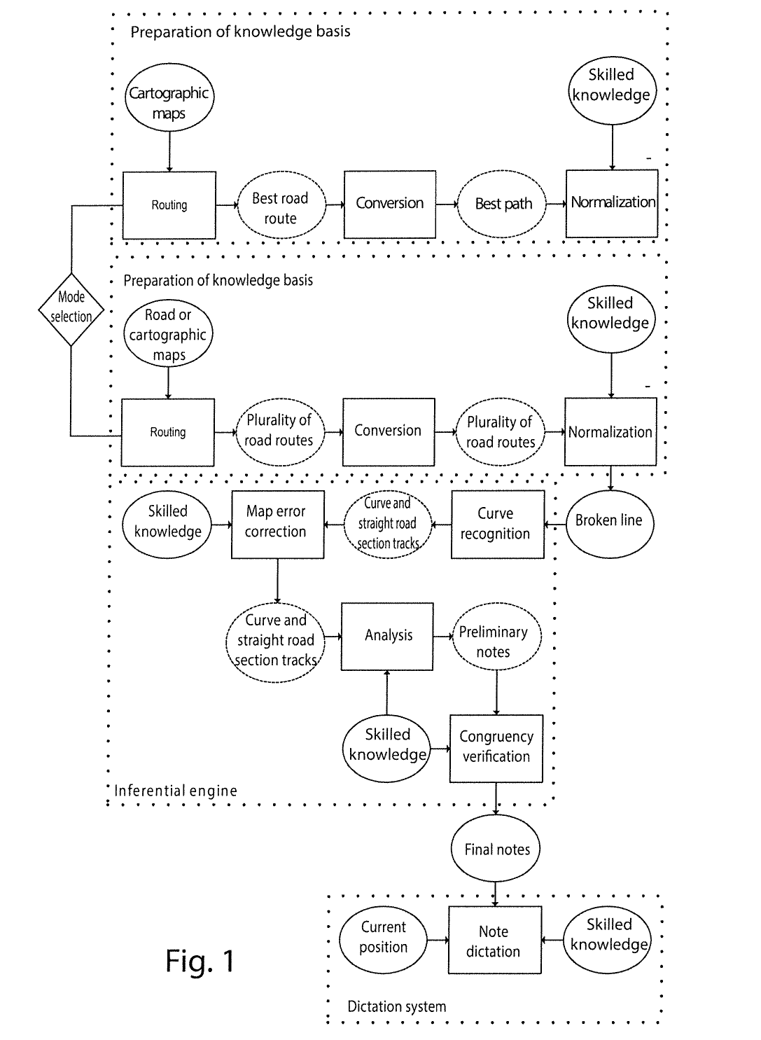

FIG. 1 shows a block diagram of the automatic recognition system of the road routes according to the present invention;

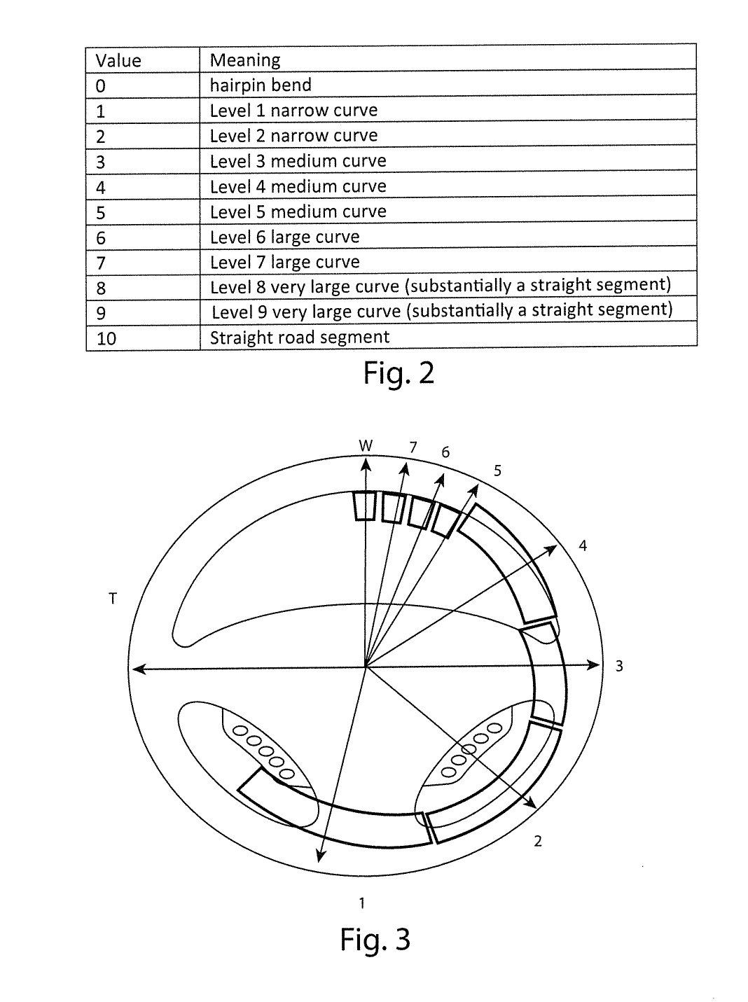

FIG. 2 shows a table including characteristic parameters used by the system according to the present invention;

FIG. 3 shows a schematic representation of the indication of the bending levels;

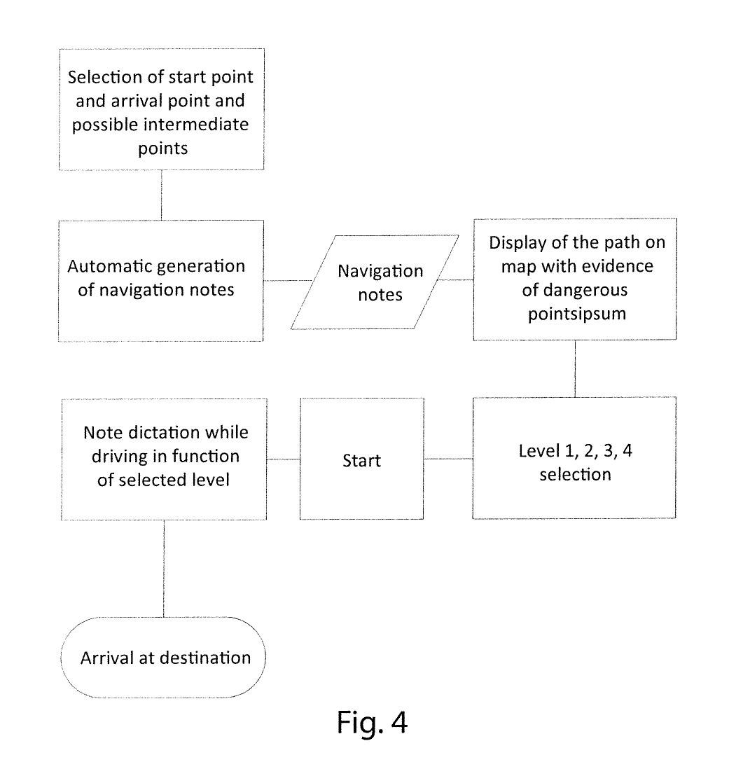

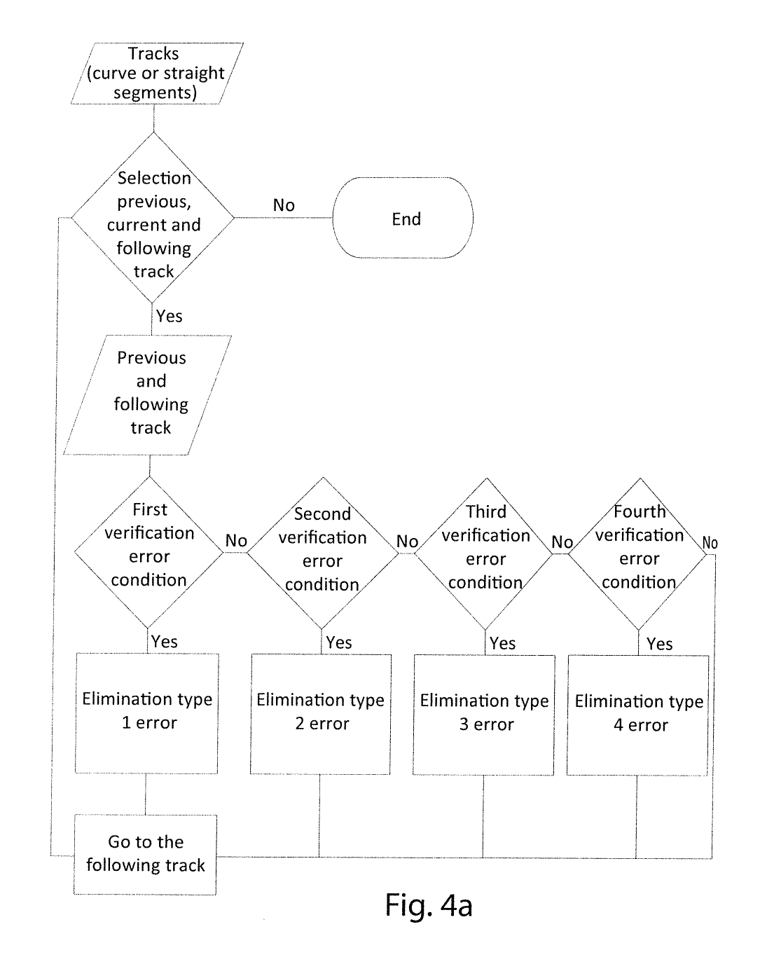

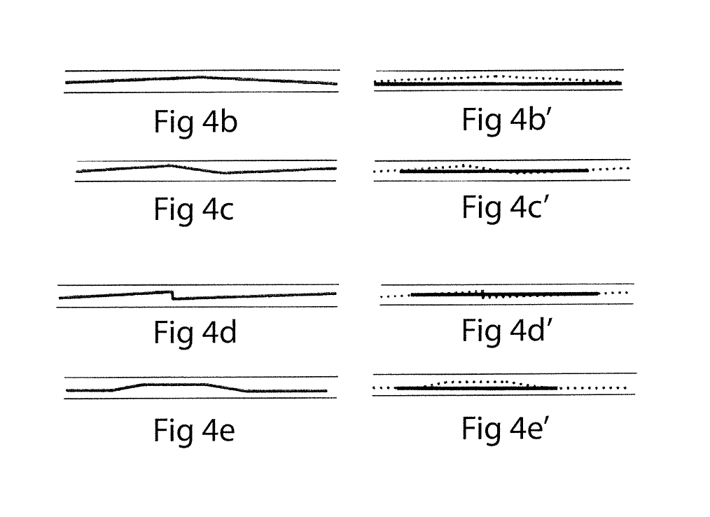

FIG. 4 shows a block diagram of the operation method of the system according to the present invention;

FIG. 4a shows a block diagram of a set of steps of the operation method of the system according to the present invention;

FIGS. 4b-4e′ show a graphic representation of error types and types of correction of said errors by means of the steps of said method;

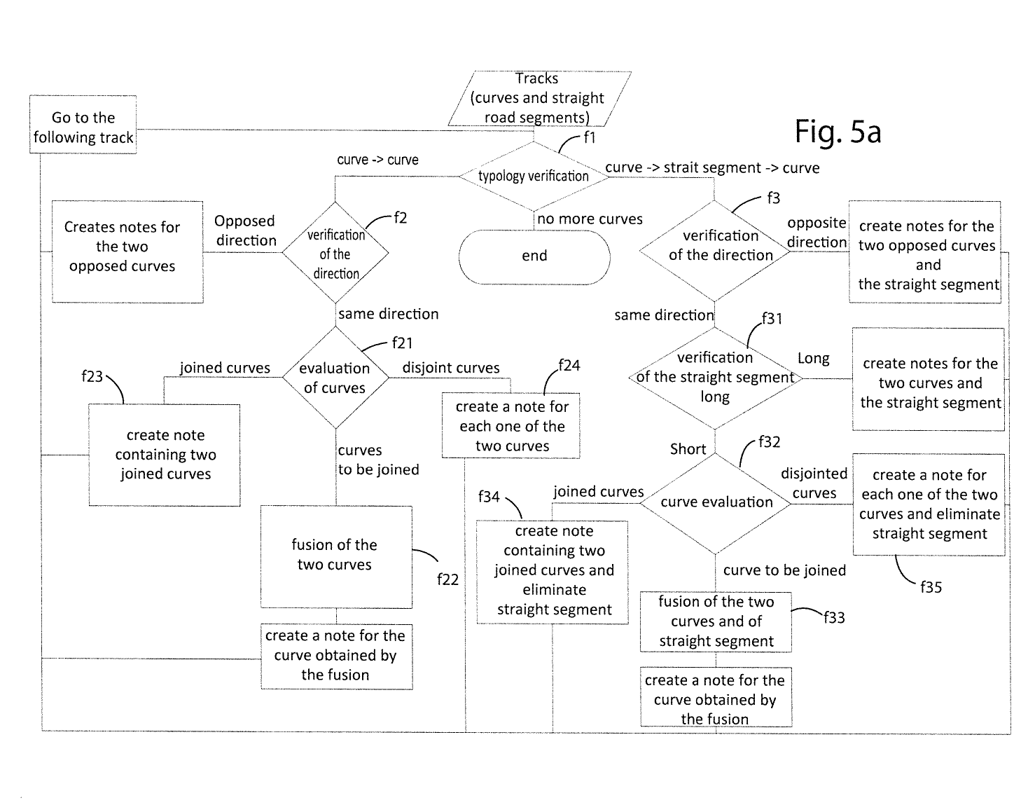

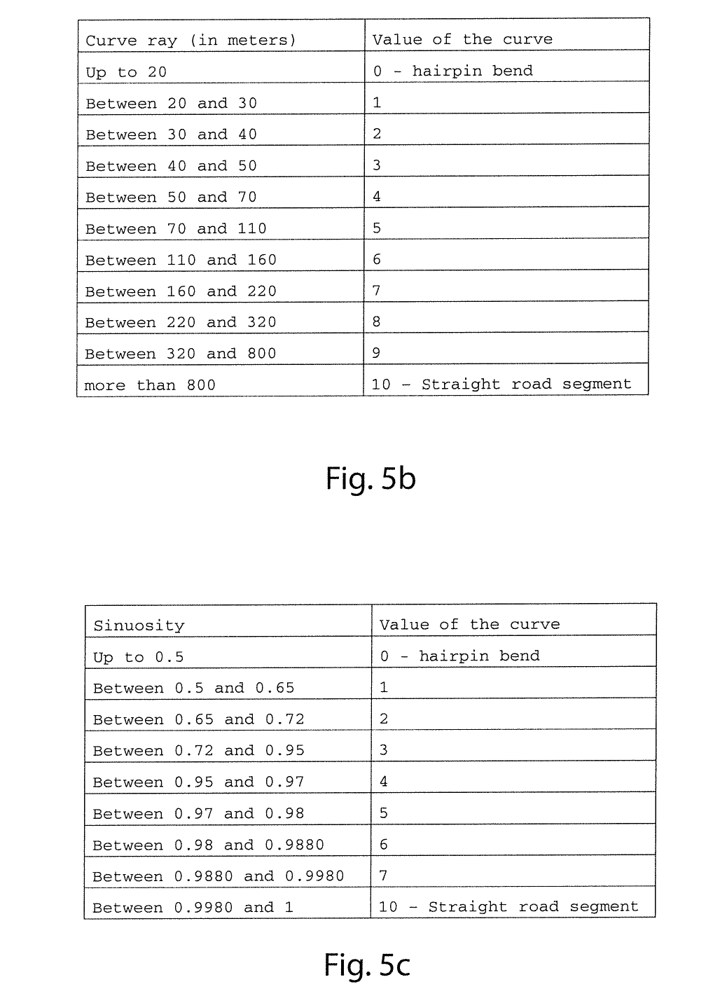

FIG. 5a shows a block diagram of a further set of steps of the operation method of the system according to the present invention;

FIG. 5b shows a table used in the steps shown in FIG. 5a;

FIG. 5c shows a further table used in the steps shown in FIG. 5a;

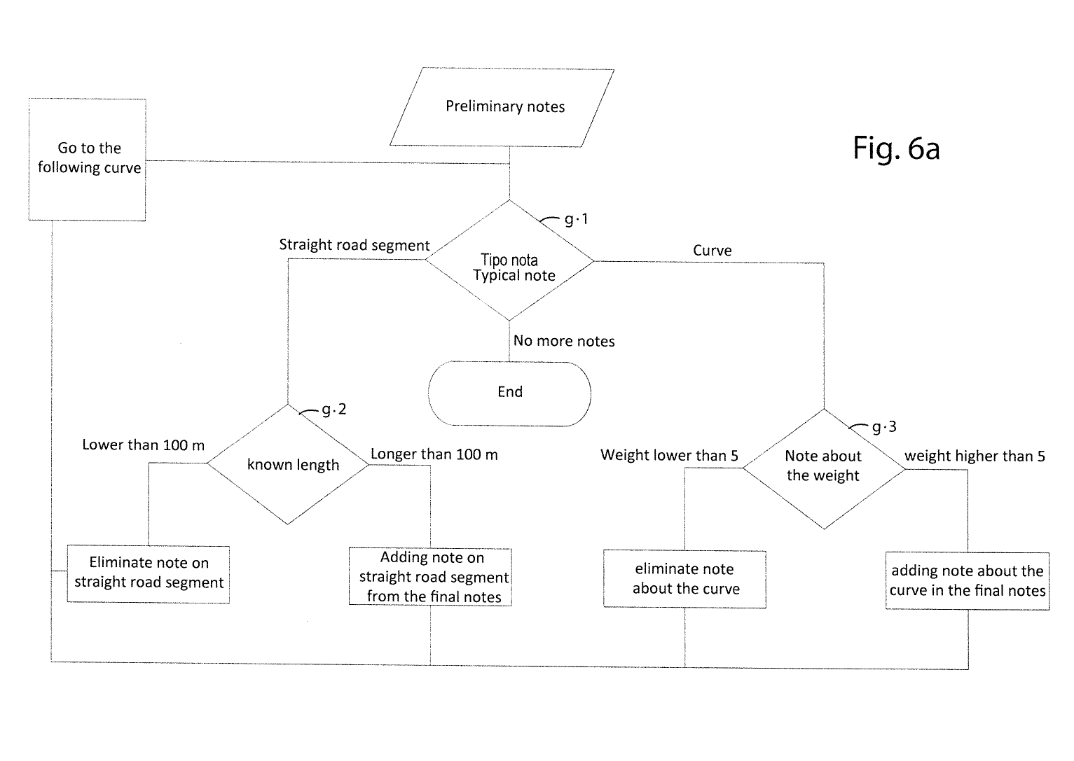

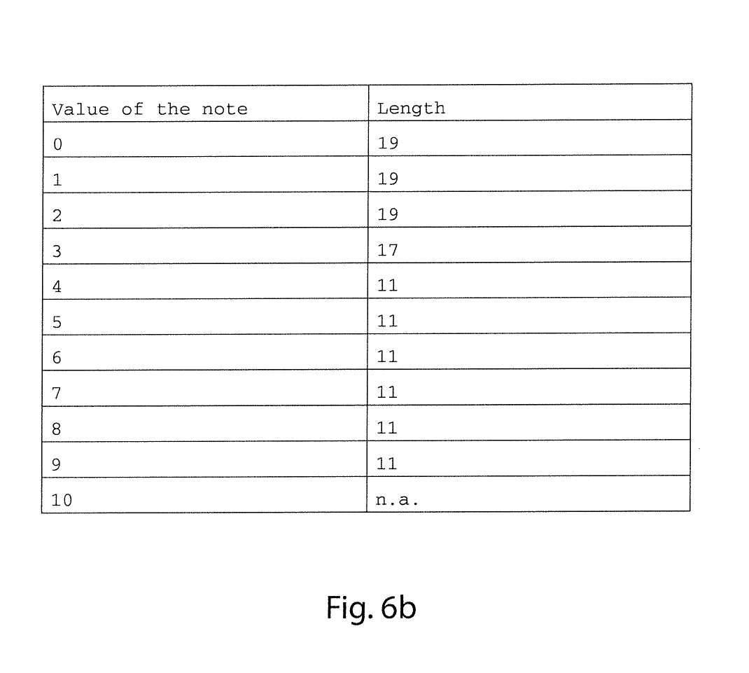

FIG. 6a shows a block diagram of a further set of steps of the operation method of the system according to the present invention;

FIG. 6b shows a table used in the steps shown in FIG. 6a;

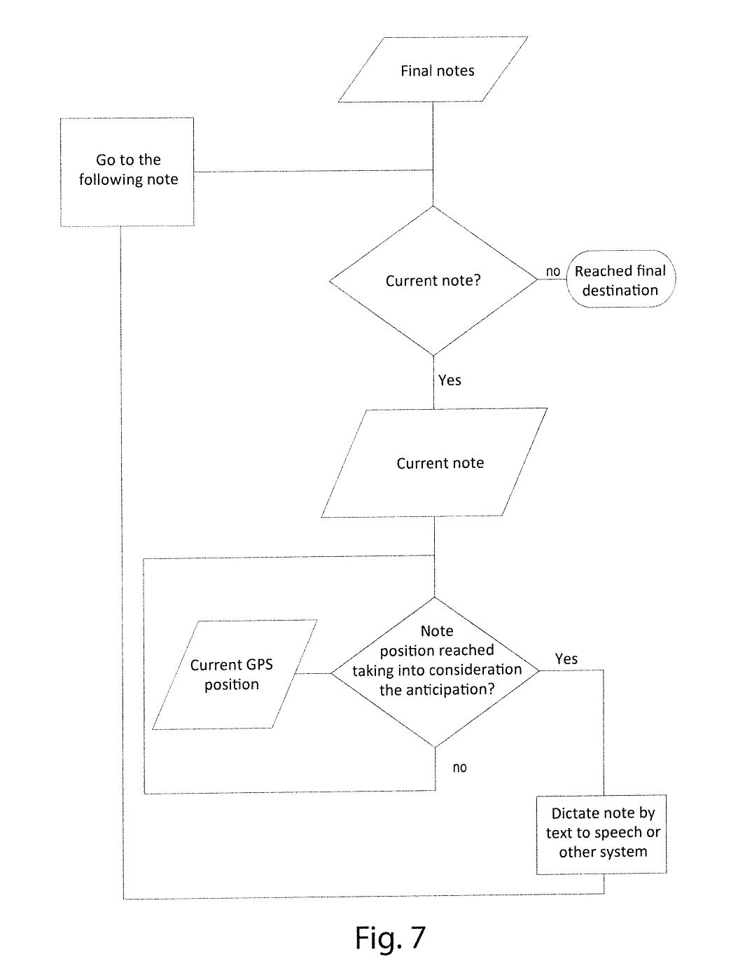

FIG. 7 shows a block diagram of a further set of steps of the operation method of the system according to the present invention;

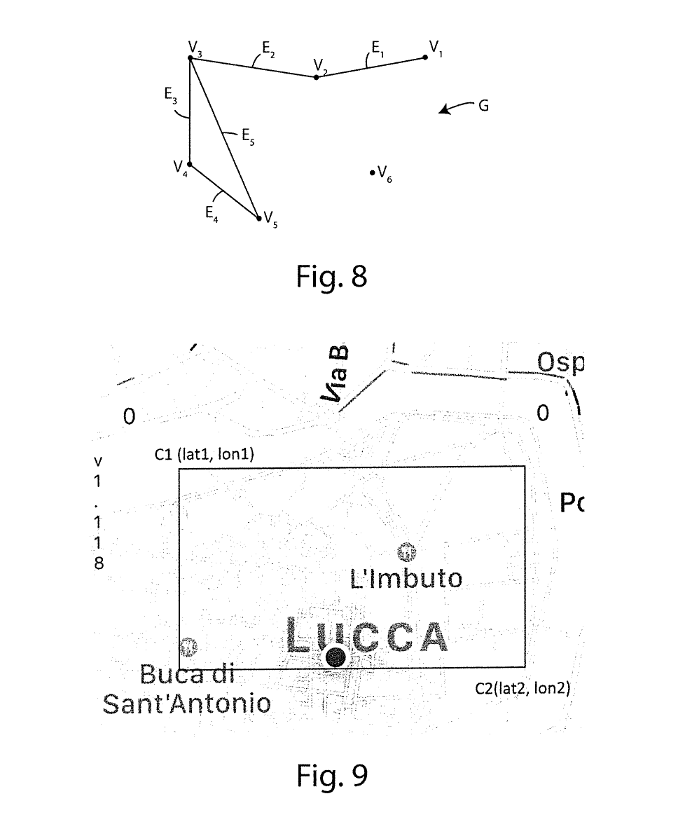

FIG. 8 shows a schematic representation of a graph;

FIG. 9 shows a schematic representation of a bounding box; and

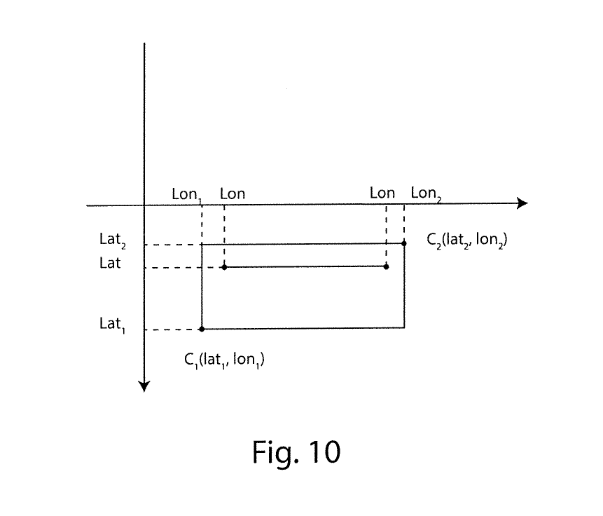

FIG. 10 shows a schematic representation of the extraction of a sub-graph by means of a bounding box.

In the various figures similar parts will be indicated with the same numerical references.

Said system S is comprised in the dashboard of a vehicle, particularly within the satellite navigation module.

In a further embodiment, said system S is installed in an external device such as a computer, a smartphone, a tablet, and the like.

Referring to FIG. 1, system S for the analysis, measurement and automatic classification of road routes according to the present invention is a system of the type belonging to the category of programs relating to artificial intelligence, particularly being an Expert System.

Said system S substantially comprises storage means 1 of a database which is the basis of knowledge of the system S, in which all data, information, deductive rules and procedural logic said system S uses during its operation, simulating the knowledge of one skilled user in a certain domain, named domain; a logic control unit 2 comprising an inferential engine, through which said system S concretely applies the notions contained in said database stored in said storage means 1 producing an elaborated map; means 3 for associating sound signals or notes to said elaborated map and dictating said notes to the pilot or driver, defined as a user while driving the vehicle, and display and interface means 4 allowing displaying the map to be followed and allowing interaction between the user and said system S.

Said system S also comprises sound reproduction means and storage means, not shown in the figures, in which there are stored the starting information, the partial results of the computation, as well as the additional information that the user requests from time to time.

Said storage means 1 and said association means 3 may be included in said logic control unit 2 of said system S, said display and interface means 4 being included in a display installed in the dashboard of the vehicle or in said external device with respect to the vehicle such as a computer, a smartphone, a tablet, and the like.

Particularly, said display and interface means 4 are implemented through known programming languages for the creation of immediate, simple, and user-friendly graphical, audio, and voice structures.

In an embodiment, the graphical interface shows on a display the map of the road route to be followed to go from the start point to the arrival point, highlighting by strong color tracks, for example, red color, the tracks associated with notes having a value lower than 3.

It is also possible providing the dashboard of the vehicle or the external device with projection means to project the map to be followed on the windscreen of the vehicle.

Making reference to FIG. 1, the continuous line ellipses indicate the data contained in said storage means 1, namely the knowledge base or the computation output of said system S; dashed lines indicate the partial data of the computation of said system S; rectangular shapes indicate algorithms transforming the input data into a form suitable for processing by the next algorithm.

Said storage means 1 comprise the data and knowledge of the skilled person in the domain. Data are road maps provided with topographic, cartographic, toponomastic, and similar information that are imported into the system S from known data sources.

The knowledge of the one skilled person in the domain includes objects and their properties, particularly segments, curves, the straight road segments, distances and angles between segments and the like, each one identified by a particular symbol, such as a right curve with a curvature radius between 30 m and 40 m is identified by the symbol “D4”, i.e. a difficulty curve 4 or a curve identified as “D4” immediately followed by a curve identified as “S3” is identified Like “D4 and S3”.

As shown in FIG. 3, the numerical value associated with the curve, i.e. its difficulty level, is objectively defined as a function of the steering angle, that is, the angle made by the steering wheel to make the curve. Knowledge also includes events, i.e. those elements changing the environment in which said system S operates, such as, for example, “the car has shifted from position X to position Y”.

In order for the data contained in said storage means 1 to be used by said system S, they must be appropriately stored in the memory of said system S.

Particularly, a connection is made, that is, a mapping between the real world and the representation of the data present in said storage means 1, i.e. it is assumed that the real world admits a description through a programming language so that said inferential engine inputted in said logical control unit 2 can infer new conclusions simply by manipulating the structure of the representation of knowledge.

Making reference to FIGS. 8, 9 and 10, the road maps contained in the knowledge base, which are displayed on said display of said system S as a track, are the visual representation of said graph G=(V, E).

The operation of the analysis, measurement and automatic classification system S of road routes of the present invention is carried out as follows.

In a first configuration phase of the S system, a user can select the way of calculating the path that will then have its display on the display in the form of a track.

In the first mode, all the possible paths, joining any first vertex vₙ of a sub graph Gₙ, as starting point, to any other second vertex vₙ₊₁ different from the first vertex vₙ as the arrival point, are calculated, therefore a user can view not only the track he is following but also all the tracks near his track.

In the second mode, only the path, joining a first vertex vₙ of a sub graph Gₙ as a starting point, to a second vertex vₙ₊₁, different from the first vertex vₙ, as the arrival point, is calculated, therefore a user can view only the track that he is following.

During a first phase 0. of configuration of said system S, a first mode or a second mode of measuring and automatic classification of said road routes is selected.

By selecting the first mode, in a phase 1. on the map displayed on said display, the user selects a bounding box by selecting the pair of geographic coordinates C1 (lat₁, lon₁) and C2 (lat₂, lon₂).

After selecting the bounding box, in step 2, system S extracts a sub graph G₁ from graph G subtended by the displayed map by selecting from set V of the start graph G all the vertices that are internal to the bounding box.

Referring also to FIG. 10, formally set V₁ is defined by the following expression:

V₁={v(lat,lon)∈V: lat≤lat₁e lon≥lon₁e lat≥lat₂e lon≤lon₂}

wherein lat₁, lon₁, lat₂ e lon₂ are latitude and longitude values of C1 and C2 points geographic coordinates defining bounding box.

Once defined the V₁ set, E₁ set is defined as the set E of arcs connecting the vertices contained in the V₁ set.

Formally, set E₁ is defined as follows:

E₁={e(v₁, v₂)∈E: v₁∈V₁e v2∈V₁}.

Once extracted sub graph, in a phase a. for each vertex v of the sub graph, chosen as the starting point, system S calculates all possible paths to arrive to a second vertex as arrival point, thus operating a routing by the known Dijkstra algorithm.

In the second mode, the system executes said step a.

directly, in which said known routing algorithm, or calculation of the shortest path, from a first starting vertex v₁ to a second arrival vertex v₂, within said graph G subtended by the map relative to the road route to follow.

In a following phase b., a conversion algorithm of the path calculated in said step a. is performed, to convert the path in a broken line that is a succession of segments, and in a subsequent phase c. a normalization algorithm of the segments of said normalized broken line in said previous step b. is performed.

Particularly, in said step a. of routing, said system S receives said cartographic data as input, such as a map of a road route to follow, and outputs, in the first mode, a plurality of paths connecting all vertices of the sub graph G₁ , in the second mode, the path linking a starting vertex v₁ to an arrival vertex v₂, within said graph G, displaying said paths in the form of a track on said display.

Said calculated path comprises a set of ordered points, described by geographic coordinates of latitude and longitude which, linked to each other consecutively, draw a broken line, also called polyline, from the starting point to the arrival point of said road route to follow.

Said broken line comprises a set of segments, each of them provided with a starting point A, a final point B, the value of the segment length, and the angle that each segment forms with the meridian, i.e. the imaginary longitudinal line joining the North Pole with the South Pole, through which the Earth's rotation axis passes.

Particularly, starting point A is indicated by spatial coordinates, i.e. a latA latitude value and a lonA longitude value, and the final point B is indicated by spatial coordinates i.e. latB latitude and lonB longitude value.

In said conversion step b., said system S receives said path calculated in said step a., particularly said starting spatial coordinate A and final spatial coordinate B of each segment forming the broken line, and outputs a set of data in a predetermined format to be used in the subsequent steps.

In a b1. sub-step it is calculated the length of each segment of said broken line as the shortest distance, i.e. the geodetic distance between the starting spatial coordinate A and the final spatial coordinate B on the terrestrial sphere, using the following formula:

lunghezza=R*arccos(sin(latA)*sin(latB)+cos(latA)*cos(latB)*cos(lonA−lonB)) (1)

wherein R=6372,795477598 Km is the medial quadratic ray of a sphere approximating the geoid.

The segment length calculation may have a 0.3% error, particularly in the polar ends, and for long distances crossing several parallel lines.

However, since the distances of said segments comprised in the broken line are of the order of meters, such an error can be ignored.

In a b2 sub-step, it is calculated angle θ that each segment forms with respect to the meridian and it is calculated as the direction from said starting point A to said final point B of each segment by the following formulas:

$$\begin{matrix}{Δ}_{ϕ} = ln ( tan ( \frac{latB}{2} + \frac{π}{4} ) / tan ( \frac{latA}{2} + \frac{π}{4} ) ) & ( 2 ) \\ Δ lon = \vert lonA - lonB \vert & ( 3 ) \\ θ = atan 2 ( Δ lon , {Δ}_{ϕ} ) & ( 4 )\end{matrix}$$

wherein Δ_{φ} is the latitude difference between said starting point A and final point B and Δlon is the longitude difference between said starting point A and final point B.

Said step c. of normalization is necessary since said segments comprising the broken line, obtained after said step b. of conversion, may have very different lengths each other, depending on both the sinuosity of the road route to follow, either by the cartography employed and the variability introduced by said routing step a.

Such differences between said segments would make the next road route analysis aimed at identifying curves and straight lines extremely complicated and inaccurate.

By sinuosity it is meant the geometry of a fraction of said road route and quantitatively expresses the irregularity of said fraction.

Particularly, given the starting and final points of a road segment, sinuosity is defined as the ratio between the geodetic distance between said starting and final points and the actual length of the road segment.

Therefore, it follows that a straight road segment has a sinuosity close to 1, because the distance between the points and the effective length coincide, while a curve is as more narrow as the sinuosity value is smaller, for example a hairpin curve has a sinuosity close to 0.5.

Therefore, in said step c. of normalization, said segments of the broken line are divided into parts of equal length so as to have a homogeneous broken line, i.e. comprised of homogeneous segments.

Said normalization step c. is carried out for each segment belonging to the broken line and comprises the following sub steps.

In sub step c.1, the length of the segment is evaluated, and if this length is greater than a predetermined threshold, e.g. 18 m, in a sub step c.2 the segment is divided into segments having a length less than or equal to 18 m.

If this length is less than 18 m, the segment remains unchanged in the broken line.

The segments thus obtained from said step c.2 substitute the initial segment in the broken line.

The 18 m value of said set threshold was established by considering an average segment length of 4 times the maximum length of a car, i.e. about 4.5 m.

Said logic control unit 2 comprises the inferential engine, which is the part of said system S which, starting from the information contained in said storage means 1, gives conclusions.

Particularly, said inferential engine makes reasoning, selects the parts of knowledge useful at a given time, eventually asks for interaction with the user.

Particularly, the following steps are performed in said inferential engine included in said control logic unit 2: a step d. of curve recognition, a step e. of error correction, a step f. of analysis and a step g. to verify the congruence.

In said step d. of the curve recognition, said inferential engine receives as input the normalized segments comprising the broken line from said storage means 1 to measure the length of each segment and the angle between two successive segments, so as to return as output a group of tracks.

Particularly, in said step d. it is calculated the angle between a segment and the next one, projecting said starting point A and final point B of each segment on a plane and applying the known formula for calculating the angle γ between two straight lines along a plane:

$$γ = arctan ( \vert \frac{m - {m}^{′}}{1 + {mm}^{′}} \vert ) \qquad ( 5 )$$

wherein m and m′ are the angular coefficients of two consecutive segments.

A right curve corresponds to an angle having a positive value, a left curve corresponds to an angle having a negative value and two straight road segments, belonging to the same straight line, correspond to a null value angle.

The angle γ calculation is carried out for all segments of the broken line so as to identify all the curves and straight road segments making up the broken line and then the road path to be driven.

From said step d. the following three sets of tracks are obtained: right curve, left curve, straight road segment.

Each track is characterized by the following qualitative and quantitative parameters, in which parameters 1) and 3) are qualitative, while parameters 2), 4)-7) are quantitative:

1) ordered set of the segments comprised in the track
2) length
3) type: right curve, left curve, straight road segment
4) overall curve angle
5) curve radius
6) sinuosity
7) value: integer from 0 to 10 as specified in the table in FIG. 2.

In said step e. of errors correction it is carried out identification and correction or deletion of errors in the track groups coming from said step d.

The correction algorithm uses the expert's knowledge and a series of general considerations and insights on the expected course of a road route and the usually expected course and methodology used by the pilot of vehicles performing GPS tracking (Global Positioning System).

Usually the most common errors in tracking, due to the realization of source cartography, are of four types.

The type one error is a zigzag, i.e. a straight road segment followed by a curve with a rightward or leftward curvature radius between 4 m and 8 m followed by another straight road segment, as shown in FIG. 4.b, and this error is corrected by replacing the two curves forming the zigzag with a new segment joining the initial part of the first straight road segment and the final part of the second straight road segment as shown in FIG. 4.b′.

Type two error is another type of zigzag, i.e. a right or left curve, followed by a small curve in the opposite direction followed by a curve in the same direction as the first one, as shown in FIG. 4.c, and it is corrected by joining previous and following segments and eliminating the central one, as shown in FIG. 4.c′.

Type three error is the non-existent segment, i.e. the segment of a few meters forming an angle greater than zero with the previous segment and the following one, which instead belong to the same straight line, as shown in FIG. 4.d and it is corrected by joining the previous segment and following one, and eliminating the central one, as shown in FIG. 4.d′.

Type four error is another type of zigzag that is frequently reported on GPS tracks when the vehicle that is driving the road route passes an obstacle on the roadway, such as a stationary or very slow vehicle, a work on progress job signal, and like.

Such a zigzag consists of a typical road route of overtaking and thus consists of a change of lane followed by the overtaking of the obstacle followed by the return back to the lane.

In the broken line said road route is a rectilinear segment followed by a left curve of about 4.5 m (lane change) followed by a straight road segment between 10 and 30 m (overtaking) followed by a right curve of about 4.5 m (return to lane), as shown in FIG. 4.e.

Said error is corrected by joining the first straight segment with the following segment to the last lane return curve, as shown in FIG. 4.e′.

Referring now to FIG. 4a, the sub steps of said step e. are as follows: in a sub step e.1, a current track is selected, if a previous track and a following track are not present, no subsequent error correction is carried out, but if a previous track and a following one are present, step e.2 is carried out.

In said step e.2. presence of type one error is verified; if it exists then it is corrected and it is passed to the following track; if it is not present, go to step e.3.

In the following step e.3., presence of the type two errors is verified; if it exists then it is corrected and passed to the following track; if it is not present, go to step e.4.

In said step e.4., the presence of the type three error is verified; if it is present then it is corrected and passed to the following track; if it is not present, go to step e.5.

In the following step e.5., the presence of the type four error is verified; if it is present, then it is corrected and passed to the following track; if it is not present, the following track is in any case analyzed. In said analysis step f., the analysis algorithm carries out the analysis of the tracks obtained from the previous step e., evaluating the length, the sinuosity, the radius of curvature of the tracks and the distance between two curves, i.e. the length of the straight tracks separating two curves to output a descriptive note for each track. At the same time as the track analysis operation, in said step f. preliminary notes are also assigned to each track.

To this end, the inference rules are employed, described in the following in sub steps f1-f.35 shown in FIG. 5a, to produce a set of preliminary notes.

Each note is described by the following qualitative and quantitative parameters:

1) tracks (ordered set of tracks comprising the notes);
2) starting point;
3) type: right, left, straight road segment;
4) subtype: normal, open, closed;
5) length;
6) value: integer from 0 to 9 as specified in the table of FIG. 2;
7) altitude;

8) possible following connected note (e.g., D3 and S4).

At the end of said step f., the road route from the starting point to the final point is enriched by a set of precise notes describing the course road.

The production of a note consists in assigning to the parameters described in the above the values derived from the calculation.

Referring to FIG. 5, in a sub step f.1, the type of the track is verified, i.e. if it is a curve track followed by another curve track or if it is a curve track followed by a straight road segment and then another curve track, or, if there are no other tracks, the algorithm ends.

In the first case, a sub-step f.2 for verifying the direction of the curve is performed, in the second case a sub-step f.3 is also carried out to verify the direction of the curve.

In sub step f.2, if the curves have opposite directions, then two notes are output for the two opposing curves. Said notes are stored in a list in the system's internal memory.

If the two curves have the same direction, an evaluation sub-step f.21 is carried out on the basis of values of the corresponding track: curve radius, sinuosity, length and angle.

Said evaluation is carried out by means of a curve radius table shown in FIG. 5b, and a sinuosity table shown in FIG. 5c.

On the basis of the evaluation, considering said two tables, the coherent curves are considered unifiable, i.e. they can be fused to form a single curve or tied together, for example a curve that opens or narrows, D4 closes D2, or untied, i.e. completely disconnected each other and therefore in all respects two distinct curves.

The evaluation of possibility of unifying curves is carried out on the basis of the following table:

TABLE 1

| | 0 | 1 | 2 | 3 | 4 | 5 | 6 | 7 | 8 | 9 | 10 |
|---|---|---|---|---|---|---|---|---|---|---|---|
| 0 | 18 | 18 | 18 | 18 | 18 | 18 | 18 | 18 | 0 | 0 | 0 |
| 1 | 18 | 18 | 22 | 22 | 22 | 22 | 22 | 22 | 0 | 0 | 0 |
| 2 | 18 | 18 | 22 | 30 | 30 | 30 | 30 | 30 | 0 | 0 | 0 |
| 3 | 18 | 18 | 22 | 30 | 30 | 30 | 30 | 30 | 30 | 30 | 0 |
| 4 | 18 | 18 | 22 | 30 | 30 | 37 | 37 | 42 | 42 | 42 | 0 |
| 5 | 18 | 18 | 22 | 30 | 30 | 37 | 42 | 50 | 50 | 50 | 0 |
| 6 | 18 | 18 | 22 | 30 | 30 | 42 | 50 | 120 | 120 | 120 | 0 |
| 7 | 18 | 18 | 22 | 30 | 30 | 42 | 50 | 120 | 120 | 120 | 0 |
| 8 | 0 | 0 | 0 | 30 | 30 | 42 | 50 | 120 | 120 | 120 | 0 |
| 9 | 0 | 0 | 0 | 30 | 30 | 42 | 50 | 120 | 120 | 120 | 0 |
| 10 | 0 | 0 | 0 | 0 | 0 | 0 | 0 | 0 | 0 | 0 | 0 |

In said table, rows are the value of the first curve, and columns the value of the second curve.

Two curves can be unified if a distance exists between them lower than the corresponding value shown in the table.

For example, a D1 curve followed by a D3 curve can be unified if there is a distance lower than 22 m.

Possibility of connecting or tiying curves is evaluated based on the following table:

TABLE 2

| | 0 | 1 | 2 | 3 | 4 | 5 | 6 | 7 | 8 | 9 | 10 |
|---|---|---|---|---|---|---|---|---|---|---|---|
| 0 | 30 | 30 | 30 | 30 | 45 | 45 | 45 | 45 | 0 | 0 | 0 |
| 1 | 30 | 30 | 30 | 30 | 45 | 45 | 45 | 45 | 0 | 0 | 0 |
| 2 | 30 | 30 | 30 | 40 | 45 | 45 | 45 | 45 | 0 | 0 | 0 |
| 3 | 45 | 30 | 30 | 40 | 45 | 55 | 55 | 55 | 55 | 55 | 0 |
| 4 | 45 | 30 | 30 | 40 | 45 | 55 | 55 | 65 | 65 | 65 | 0 |
| 5 | 45 | 30 | 30 | 40 | 45 | 55 | 55 | 65 | 65 | 65 | 0 |
| 6 | 45 | 30 | 30 | 40 | 45 | 55 | 15 | 15 | 15 | 15 | 0 |
| 7 | 45 | 30 | 45 | 40 | 45 | 15 | 15 | 15 | 15 | 15 | 0 |
| 8 | 0 | 0 | 0 | 40 | 45 | 15 | 15 | 15 | 15 | 15 | 0 |
| 9 | 0 | 0 | 0 | 40 | 45 | 15 | 15 | 15 | 15 | 15 | 0 |
| 10 | 0 | 0 | 0 | 0 | 0 | 0 | 0 | 0 | 0 | 0 | 0 |

In said table, the rows are the value of the first curve, the columns the value of the second curve.

Two curves can be tied if they cannot be unified and if there is a distance less than the corresponding value shown in the table.

For example, a D1 curve followed by a D3 curve can be tied each other if there is a distance less than 30 m.

If the curves are unifiable, a new note is generated in a sub step f.22 by assigning to the “tracks” attribute the two curved tracks of the fusion.

If the curves are tied each other, in a sub step f.23 two notes are produced, one for each curve, and are tied together by assigning the attribute “following note” the second note, e.g. D3 becomes D2.

Joining between two notes may be of the “Open” or “Close” type.

The “Open” connection occurs when the second curve has a curvature radius greater than the first one, i.e. the curve tends to open.

The “Close” connection occurs when the curvature radius of the second curve is lower than the curvature radius of the first curve, i.e. the curve tends to close.

If the curves are untied, i.e. a straight road segment is present, two distinct notes are produced in sub step f.24, one for each curve.

Returning to step f.3, if the curves have opposite directions, then two notes for the two opposing curves and an extension note are produced.

Also said notes are stored in a list in the internal memory of the calculation device, if the two curves have the same direction, an evaluation sub-step f.31 of said straight road segment by means of the above tables is carried out.

The evaluation gives two different cases: long straight road segment, i.e. longer than 20 m and short length, i.e. lower than or equal to 20 m.

In the first case, the two curves are completely untied and separated by a substantial straight road segment.

In this case, three separate notes are produced, one for each curve and one for the straight road segment.

In the second case, an evaluation sub-step f.32 of the two curves is carried out, similar to that carried out in the sub step f.21.

On the basis of the evaluation, the concordant curves can be: unifiable, that is, they can be fused to form a single curve, connected together, for example a curve that opens or closes (D4 closes D2), or untied, i.e. completely disconnected and therefore two distinct curves.

Similarly to sub step f.21, if the curves are unifiable, a new note is created in a sub step f.33 by merging the first curve track, the track of the following straight road segment, and the track of the second curve, and then eliminating the three merged tracks.

If they are tied each other, a sub-step f.34 is carried out, in which two notes are produced, one for each curve, and are tied together by assigning to the attribute “following note” the second note (e.g. D3 becomes D2).

If the curves are untied, a step f.35 is executed in which three distinct notes are produced, one for each track.

Said step f. is repeated until the last track comprising the road route.

In said step g. of the consistency check, the final notes are produced by carrying out a consistency check of the preliminary note on the basis of the minimum length table, shown in FIG. 6b, obtained from considerations deriving from expert knowledge such as “a 18 mt long right or left note of value 9, can be neglected because, being too large and short, does not represent a risk to the pilot” or “if a wide curve, e.g. S7, is immediately followed by a narrow curve, e.g. S1, the wide curve must be eliminated.”

During said coherency verification stage g., not-coherent notes are deleted.

Referring to FIG. 6a, in a sub step g.1, the preliminary notes from the previous step f. are evaluated, and it is distinguished between a note for a straight road segment and a note for a curve.

If the note is for a straight road segment, a sub-step g.2 is carried out, in which the straight road segment is evaluated; if it is less than 100 m, it is eliminated, if it is more than 100 m, the preliminary note becomes the final note.

If the note is related to a curve, a note evaluation step g.3 is performed.

It is taken into consideration its value both in absolute terms and in relation to the previous and following note.

The evaluation assigns a weight to the current note ranging between 1 and 10.

More specifically, such weight is calculated by the table of the minimum lengths shown in FIG. 6b and of the rules of the type:
if the length of the track associated with the note is less than the corresponding value defined in the table, the weight of the note is 1;
if the note value is greater than 5 and the track length associated with the note is less than 20 m and the previous note and the following note have both values less than 5, the weight of the note is 2.

If this weight is less than or equal to 5, the note is deleted, if this weight is greater than 5, the preliminary note becomes a final note.

Said sound signal association means 3 associate the notes generated by said inferential engine to the map processed by said inferential engine and dictate them to the user while driving the vehicle.

Said notes enrich the road route with information that helps increase safety while driving.

The user selects the start point, the arrival point, and any intermediate points specifying the address or GPS coordinates of said points.

Once the road route has been defined from the starting point to the arrival point passing through any intermediate points, and run is started and thus also navigation, said association and dictation means 3 of the notes announce, by means of sound reproduction and/or visualization on a display and/or projection on a reflective medium, notes while driving, anticipating dictation so that the note can be timely listened and/or displayed by the user, which may then suitably modify the guide.

Said association means 3 help the user while driving by informing him/her about the dangers of the road ahead in the same way as a human navigator makes to the a rally driver during a race.

Therefore, said association means 3 emulates the copilot's behaviour during a rally and is also part of the type of expert systems, comprising a knowledge base and an inferential engine.

The dictation rate, the anticipation with respect to dictation to the actual point of the note, are defined on the basis of the following table of anticipations:

TABLE 3

| | | | | | | | | | | | |
|---|---|---|---|---|---|---|---|---|---|---|---|
| 9 | 1, 5 | 1, 5 | 2, 0 | 2, 5 | 3, 0 | 3, 5 | 3, 5 | 3, 5 | 3, 5 | 3, 5 | 3, 5 |
| 8 | 1, 5 | 1, 5 | 2, 0 | 2, 5 | 3, 0 | 3, 5 | 3, 5 | 3, 5 | 3, 5 | 3, 5 | 3, 5 |
| 7 | 1, 5 | 1, 5 | 2, 0 | 2, 5 | 3, 0 | 3, 5 | 3, 5 | 3, 5 | 3, 5 | 3, 5 | 3, 5 |
| 6 | 1, 5 | 1, 5 | 2, 0 | 2, 5 | 3, 0 | 3, 5 | 3, 5 | 3, 5 | 3, 5 | 3, 5 | 3, 5 |
| 5 | 1, 5 | 1, 5 | 2, 0 | 2, 5 | 3, 0 | 3, 5 | 3, 5 | 3, 5 | 3, 5 | 3, 5 | 3, 5 |
| 4 | 1, 5 | 1, 5 | 2, 0 | 2, 5 | 3, 0 | 3, 5 | 3, 5 | 3, 5 | 3, 5 | 3, 5 | 3, 5 |
| 3 | 1, 5 | 1, 5 | 2, 0 | 2, 5 | 3, 0 | 3, 5 | 3, 5 | 3, 5 | 3, 5 | 3, 5 | 3, 5 |
| 2 | 1, 5 | 1, 5 | 2, 0 | 2, 5 | 3, 0 | 3, 5 | 3, 5 | 3, 5 | 3, 5 | 3, 5 | 3, 5 |
| 1 | 1, 5 | 1, 5 | 2, 0 | 2, 5 | 3, 0 | 3, 5 | 3, 5 | 3, 5 | 3, 5 | 3, 5 | 3, 5 |
| 0 | 1, 5 | 1, 5 | 2, 0 | 2, 5 | 3, 0 | 3, 5 | 3, 5 | 3, 5 | 3, 5 | 3, 5 | 3, 5 |
| | 0 | 1 | 2 | 3 | 4 | 5 | 6 | 7 | 8 | 9 | 10 |

In said table advance seconds are given for dictation of a note with respect to the actual note point with a deviation of +/−0.2 sec, e.g. in passing from a D3 to an S2, note S2 must be said about 2 seconds ahead.

The inferential engine of said association means 3 is limited to detecting the next note to be dictated on the basis of the GPS position of the vehicle, to determine the exact moment in which dictating it by means of the above table, and activating the vocal dictation system, by acoustic signal or other signaling.

Dictation modes depend on the selected guide level, which typically depends on the user's experience or ability to drive.

The user set and selectable guide levels on said display and interface means 4 are substantially four:

1) basic level, easier, called “mother level”, provides the only dictation of the curves by announcing four different levels of difficulty for each curve:
a. hairpin bend
b. easy
c. medium
d. difficult

Said level is specifically designed for those who have a generally prudent guide and little familiarity to guide.

At the second level, called “father level”, the notes are dictated with more detail by announcing besides the level of the curve, as in the mother level, even the possible modification of the curvature radius, announcing in that case “open” or “close”. This level is specifically thought for those who have a generally cautious guide but have a good practice in driving.

At the third level, called “co-pilot level”, the notes are dictated in greater detail by specifying:

a. the level of the curve (T, 1, 2, 3, 4, 5, 6, 7)
b. the direction of the curve (D or S)
c. if necessary, change the curvature radius by announcing “open” or “close”.

This level is specifically designed for those who have a sportive guide and are well versed in driving.

At the fourth level, the top level called “pilot level”, corresponding to the rally driver, notes are dictated with all the available details following the typical formalism of the navigation notes by specifying the following parameters:

a. the level of the curve (T, 1, 2, 3, 4, 5, 6, 7, 8, 9);
b. the direction of the curve (D or S);
c. the curve type (short, normal, long, very long);
d. if necessary, change the curvature radius by announcing “open” or “close”.

A curve is defined as “short” if its length is less than the value shown in the following table:

TABLE 4

| Known Value | Known Length |
|---|---|
| 0 | 0 |
| 1 | 12 |
| 2 | 12 |
| 3 | 14 |
| 4 | 20 |
| 5 | 20 |
| 6 | 0 |
| 7 | 0 |
| 8 | 0 |
| 9 | 0 |

A curve is defined as “long” if its length exceeds the value given in the following table:

TABLE 5

| Known value | Known Length |
|---|---|
| 0 | 50 |
| 1 | 30 |
| 2 | 35 |
| 3 | 45 |
| 4 | 90 |
| 5 | 120 |
| 6 | 120 |
| 7 | 120 |
| 8 | 0 |
| 9 | 0 |

A curve is defined as “long long” if its length exceeds the value shown in the following table:

TABLE 6

| known value | Known lenght |
|---|---|
| 0 | 0 |
| 1 | 55 |
| 2 | 60 |
| 3 | 80 |
| 4 | 120 |
| 5 | 180 |
| 6 | 200 |
| 7 | 200 |
| 8 | 0 |
| 9 | 0 |

A curve is defined as “normal” if it does not fall into any of the above mentioned types.

Said system S operates from the starting and arrival points selected according to the following algorithm:

1) starting and arrival points are selected, for example by address, by indicating the points on the map with the finger or the mouse pointer;
2) notes are calculated as described in the above,
3) notes on the map are displayed waiting for the start,
4) at the start of the said system S, dictation begins continues until arrival at destination.

During the run, the dictation of each note occurs with a certain advance in relation to the actual point on the map to which the note is connected (starting point of the note).

Such advance is defined as the distance in meters from the starting point of the calculated note according to the instantaneous speed of the vehicle on the basis of the following formula:

distance=5+speed²+speed*advance table[value previous note][value current note] (6)

wherein the speed variable is the vehicle instantaneous speed measured in tens of Km/h and the variable Advance Table is the advance table 3.

The Value Advance Table value [Previous valueNote] is the value of the cell corresponding to the known.Previous.value line and the known.Current value column.

For example, if the vehicle travels at 40 km/h and passes from a value note 3 to a value note 4, the distance will be: 5+4²+4*3=33.

The note will therefore be dictated by said system S when the vehicle is, at the starting point of the note, at the distance established by the above formula.

In use, the user activates said system S contained in said dashboard or in said device by means of said display and interface means 4.

He/she sets the starting point and the arrival point of the road route to be travelled and the desired driving level.

Said system analyzes, measures and classifies the road route as described in the above and allows the visualization of the result of that classification on the map corresponding to said road route on a display provided in the dashboard of the vehicle, or on another equivalent device.

The user can also display the map on the vehicle windshield.

Further, the system S dictates the notes concerning the road route during the navigation while respecting dictation times consistent with user guidance manoeuvres.

During the driving, said sound reproduction means dictate notes, considering the advance timing defined in the above, by means of a known Text-To-Speech system and on the basis on the selected guide level.

As it is well evident from the above description, the system S provides a safe guide since the user, while driving, visually and acoustically knows in advance the characteristics of the road route he/she is following.

The present invention has been described in an exemplificative, but not limitative, way according to its preferred embodiments, but it is to be understood that variations and/or modifications may be introduced by those skilled in the art without thereby departing from the scope as defined by the enclosed claims.

1. An analysis, measurement and automatic classification system (S) of road routes such as urban and suburban routes, a circuit, a racetrack, from a starting point to an arrival point, for driving a vehicle by a user on said road routes, said system (S) comprising:
storage means (1) of a base of data to be processed, such as road maps provided with topographical, cartographic, toponomy information, and the like, analysis, measurement and classification rules of these road routes,
a control logic unit (2), operatively connected to said storage means (1), equipped with processing means of said data to be processed, comprising a calculation program of inferential type that, on the basis of said data, determines and provides as output a drawn map for the driving from said starting point to said arrival point.

2. The system (S) according to claim 1, characterized in that it comprises association means (3) of sounding signals to said drawn map, capable to inform said user while he drives along said road route.

3. The system (S) according to claim 1, characterized in that it comprises display and interface means (4) of said drawn map, such as a display and the like.

4. An analysis, measurement and automatic classification method of road routes such as urban and suburban routes, a circuit, a racetrack, from a starting point to an arrival point, for driving a vehicle by a user on said road routes, implemented by the system (S) according to the preceding claims, comprising the following steps:
0. configuration phase of said system (S) for selecting a first mode and a second mode for automatically measuring and classifying said road routes;
1. if the first calculation mode is selected, select a bounding box on a road map, underlying a starting graph (G) defined by a set of vertices (V) and a set of arcs (E), said road map being relative to said road route by selecting a pair of geographic coordinates C₁ (lat₁, lon₁) and C₂(lat₂, lon₂);
2. extracting a sub graph (G₁) defined by a subset of vertices (V₁) and a subset of arcs (E₁) from said starting graph (G) by selecting from said set of vertices (V) of said starting graph G) a subset of vertices (V₁) including all vertices that are included within said bounding box, so that
V₁={v(lat, lon)∈V:lat≤lat₁ and lon≥lon₁ and lat≥lat₂ and lon≤lon₂}
and selecting from said set of arcs (E) of said starting graph (G) a subset of arcs (E₁) connecting all vertices contained in said subset of vertices (V₁) so that:
E1={e(v1,v2)∈E:v1∈V1ev2∈V1};
a. if the first mode is chosen for each vertex of said subset of vertices (V₁) calculate the possible paths to reach any other vertex of said subset of vertices (V₁) by means of a routing algorithm; if the second mode is chosen, calculate a path connecting a starting vertex, coinciding with said starting point of the road route, to an arrival vertex, coinciding with said arrival point of said road route, comprising a set of arcs, each having a starting vertex A and a final vertex B;
a1. converting said arcs into segments;
b. converting said path calculated in said step a. in a broken line comprising said segments;
c. normalizing said segments of said broken line, dividing said segments into parts of equal length so as to have a homogeneous broken line, i.e. composed of segments of comparable length;
d. associating to each segment of said broken line a length and the angle between each segment and the meridian, projecting said starting point A and said final point B of each segment on a plane and applying the known formula for the calculation of the angle γ between two straight lines on a plane:
$$γ = arctan ( \vert \frac{m - {m}^{′}}{1 + mm′} \vert ) \qquad ( 5 )$$
wherein m and m′ are angular coefficients of two consecutive segments, at an angle having a positive value corresponds to a right curve, at a angle having a negative value corresponds a left curve and at a zero value angle correspond to two straight line segments belonging to the same straight line, compute the y angle for all the segments of the broken line, individuating all the curves and straight line comprising the broken line and output a first set of tracks containing all the right curves, a second set of tracks containing all the left curves and a third set of tracks containing all the straight line;
e. correcting errors due to the realization of said road map, present in said group of tracks;
f. analyzing the groups of correct tracks obtained from the preceding step e., evaluating the length, the sinuosity, the radius of curvature of the tracks and the distance between two curves, this latter given by the length of the straight line which separate two curves and assigning preliminary notes to each of the tracks;
g. checking the coherence of said preliminary notes and generation of final notes.

5. The method according to claim 4, characterized in that said step b. comprises the following sub-steps:
b1. calculating the length of each segment of said broken line as the geodetic between the spatial coordinate of the said starting point A and the spatial coordinate of said final point B on the terrestrial sphere, by means of the following formula:
lunghezza=R*arccos(sin(latA)*sin(latB)+cos(latA)*cos(latB)*cos(lonA−lonB)) (1)
wherein R=6372,795477598 Km is the average quadratic radius of a sphere that approximates the geoid;
b2. calculating the angle θ that each segment forms with respect to the meridian, as the direction from said starting point A to said final point B of each segment using the following formulas:
$$\begin{matrix}Δϕ = ln ( tan ( \frac{lat B}{2} + \frac{π}{4} ) / tan ( \frac{lat A}{2} + \frac{π}{4} ) ) & ( 2 ) \\ Δ lon = \vert lonA - lonB \vert & ( 3 ) \\ θ = a tan 2 ( Δ lon , Δϕ ) & ( 4 )\end{matrix}$$
wherein Δ_{φ} is the difference of latitude between said starting point A and final point B, and Δlon is the difference of longitude between said starting point A and final point B.

6. The method according to claim 4, characterized in that said step c. comprises the following sub-steps:
c.1 evaluating the length of the segment,
c.2 if said length is greater than a predetermined threshold, such as 18 m, said segment is divided into segments of length less than or equal to 18 m.

7. The method according to claim 4, characterized in that said step e. comprises the following sub-steps:
e.1 selecting a track to be examined, if there are not also a previous track and a subsequent track, no error correction is carried out, but if there are a previous track and a subsequent track, a sub-step e.2 occurs;
e.2. checking the presence of the error of type one, i.e. a straight line followed by a curve with a radius of curvature between 4 m and 8 m rightward or leftward followed by another straight line, if present then corrected by replacing the two curves forming the zigzag with a new segment connecting the initial part of the first straight line and the final part of the second straight line the following track is analyzed, if there is no error, a sub-step e.3 occurs;
e.3. checking the presence of the error of type two, i.e. a right or left curve followed by a small curve in the opposite direction followed by a curve in the same direction as the first one, if it is present then it is corrected by connecting the initial and final curves and eliminating the opposite curve the following track is analyzed, if there is no error, a sub-step e.4 occurs;
e.4. checking the presence of the error of type three, i.e. the segment of few meters forming an angle greater than zero with the previous segment and the next one which instead belong to the same straight line, if it is present then it is corrected by connecting the previous and the next segment and eliminating the central one, the following track is analyzed, if there is no error, a sub-step e.5 occurs;
e.5. checking the presence of the error of type four, i.e. a straight segment followed by a left curve of about 4.5 m, followed by a straight line ranging between 10 m and 30 m, followed by a right curve of about 4.5 m, if it is present then it is corrected by connecting the first straight segment with the segment following the last curve of lane return, the following track is at the same analyzed.

8. The method according to claim 4, characterized in that said step f. comprises the following sub-steps:
f.1 checking the type of the track, if it is a curve track followed by another curve track, running a sub-step f.2 or if it is a curve track followed by a straight track and then by another curve track, running a sub-step f.3, if there are no subsequent tracks, ending the sub-step f.1;
f.2 if the curves have opposite directions, giving out two notes for two opposite curves, if the two curves have the same direction, running a sub-step f.21;
f.21 evaluating the curve on the basis of the values of the corresponding track: the radius of curvature, sinuosity, length and angle, if the curves are unifiable, i.e. if they can be fused to realize a single curve, according to predetermined criteria and tables, running a sub-step f.22, if the curves are tied together, i.e. if the cannot be unified and in case a distance lower than a set value exists between them, running a sub-step f.23, i.e. if the curves are untied, i.e. if among them an extension or straight line is present, running a sub-step f.24;
f.22 generating a new note by assigning to the attribute “tracks” the two tracks obtained by tying;
f.23 if the curves are tied to each other, generating two notes, one for each curve track, and tying them to each other by assigning to the attribute “following note” the second note;
f.24 if the curves are untied, generating two distinct notes, one for each curve;
f.3. if the curves have opposite directions, generating two notes for the two opposed curves and one note for the extension, if the two curves have the same direction, running a sub-step f.31 to evaluate such extension by means of predetermined rules, in the case of a long extension, i.e. having a length longer than 20 m. the two curves are completely untied and separated by a extension, generating three distinct notes, one for each curve and one for the extension, in case of a short extension, i.e. having a length lower than or equal to 20 m, running a sub-step f.32 to evaluate the two curves;
f.32 evaluating the two curves, if they are unifiable to form a single curve, running a sub-step f.33, if the curves are tied together, running a sub-step f.34;
f.33 generating a new note by merging the track of the first curve, the track of the successive extension and the track of the second curve and then erasing the three merged tracks;
f.34 generating two notes, one for each curved track, and merging them together by assigning to the attribute “following note” the second note, if the curves are untied, running the sub-step f.35;
f.35 generating three distinct notes, one for each track.

9. The method according to claim 4, characterized in that said step g. comprises the following sub-steps:
g.1 evaluating the preliminary notes coming from the preceding step f. and distinguish between a note for an extension and a note for a curve;
g.2 if the note is for an extension, evaluating the extension, if it is less than 100 m it is deleted, if it is greater than 100 meters, the preliminary note becomes a final note;
g.3 if the note relates to a curve, running an evaluation step of the note and classifying it a final note.

10. The method according to claim 4, characterized in that it comprises a step of dictating said final notes during the driving of said vehicle in which a calculation is made of the moment in which dictating the note related to the position of the vehicle.
